(19) United States
(12) Patent Application Publication
(10) Pub. No.: US 2024/0202661 A1
(43) Pub. Date: Jun. 20, 2024

(54) DETERMINING A GEOLOCATION AND A NAVIGATION PATH ASSOCIATED WITH AN ORDER PLACED WITH AN ONLINE CONCIERGE SYSTEM

(71) Applicant: Maplebear Inc. (dba Instacart), San Francisco, CA (US)

(72) Inventors: Ashish Sinha, Jersey City, NJ (US); Collin Yen, San Francisco, CA (US)

(21) Appl. No.: 18/085,396

(22) Filed: Dec. 20, 2022

(51) Int. Cl. G06Q 10/0875; G01C 21/34; G06F 18/23

(52) U.S. Cl. CPC G06Q 10/0875; G01C 21/3476; G06F 18/23

(57) ABSTRACT

An online concierge system receives data points associated with picking up and delivering orders and arriving at retailer/delivery locations from picker client devices and executes a clustering process on one or more sets of the data points. The system determines a geolocation associated with each location based on the clustering process and identifies one or more points of interest associated with each location based on rules applied to the data points. The system receives information describing an order, identifies pairs of data points associated with a location associated with the order, and determines a navigation path including a sequence of points of interest for servicing the order based on points of interest associated with the location and a difference between times associated with each pair of data points. The system sends the geolocation and navigation path to a picker client device associated with a picker servicing the order.

### BACKGROUND

Online concierge systems may allow customers to place online delivery orders and may match the orders with pickers who service the orders on behalf of the customers. Pickers may service orders by performing different tasks involved in servicing the orders, such as driving to retailer locations, collecting items included in the orders, purchasing the items, and delivering the items to customers. When servicing orders, pickers often rely on geographical locations or “geolocations” provided by third-party systems (e.g., third-party mapping or navigation applications, websites, etc.) for retailer locations or delivery locations. For example, when servicing an order, a picker may use a navigation application to guide them to a retailer location to pick up the order or to a delivery location to deliver the order, in which the navigation application determines a route for the picker based on a location of the picker's client device and a geolocation (e.g., latitude and longitude coordinates) for the retailer or delivery location.

However, geolocations provided by third-party systems sometimes may be inaccurate or unhelpful, causing pickers to waste significant amounts of time. For example, if the geolocation for a delivery location provided by a third-party system is more than 100 meters from the actual delivery location, a picker may navigate to an incorrect location and spend a significant amount of time trying to find the correct delivery location. Additionally, even if geolocations for retailer locations or delivery locations are accurate, if the retailer or delivery locations are within large buildings (e.g., stores within malls, apartments in apartment complexes, offices within office buildings, etc.), pickers may still waste significant amounts of time navigating to them. For example, if the delivery location for an order is an apartment within a large multi-story apartment complex with multiple, entrances, staircases, and elevators, a picker may spend more time than necessary navigating to the delivery location if they enter the building from an entrance furthest from the delivery location, have trouble finding an elevator or a staircase, turn down the wrong hallway, etc. The significant amounts of time that may be wasted by pickers navigating to incorrect locations or within buildings may result in late or failed deliveries and negative experiences for both pickers and customers.

### SUMMARY

In accordance with one or more aspects of the disclosure, an online concierge system determines a geolocation and a navigation path associated with an order placed with the online concierge system. More specifically, the online concierge system receives data points from picker client devices associated with pickers, in which the data points include a first set of data points and a second set of data points. The first set of data points is associated with arriving at one or more locations included among a plurality of locations, while the second set of data points is associated with picking up orders from one or more locations included among the plurality of locations and delivering orders to one or more locations included among the plurality of locations. The online concierge system executes a clustering process on the first and/or second set of data points by generating, from the first and/or second set of data points, one or more clusters associated with each location included among the plurality of locations, and identifying a cluster associated with each location based on the first and/or second set of data points included in each cluster. The online concierge system determines a geolocation associated with each location included among the plurality of locations based on the first and/or second set of data points included in the identified cluster and identifies one or more points of interest associated with each location included among the plurality of locations based on one or more rules applied to the data points. The online concierge system then receives order information associated with a new order placed with the online concierge system, in which the order information describes a location associated with the new order. The online concierge system identifies, from the data points, one or more pairs of data points associated with the location, in which each pair of data points is associated with an order and includes a data point from the first set of data points and another data point from the second pair of data points. The online concierge system determines a difference between a pair of times associated with each pair of data points and identifies a navigation path including a sequence of points of interest for servicing the new order based on the point(s) of interest associated with the location and the difference between the pair of times associated with each pair of data points. The online concierge system then sends the geolocation associated with the location and the navigation path to a picker client device associated with a picker servicing the new order.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for determining a geolocation and a navigation path associated with an order placed with an online concierge system, in accordance with one or more embodiments.

FIGS. 4A-4C illustrate examples of navigation paths for servicing an order, in accordance with one or more embodiments.

### DETAILED DESCRIPTION

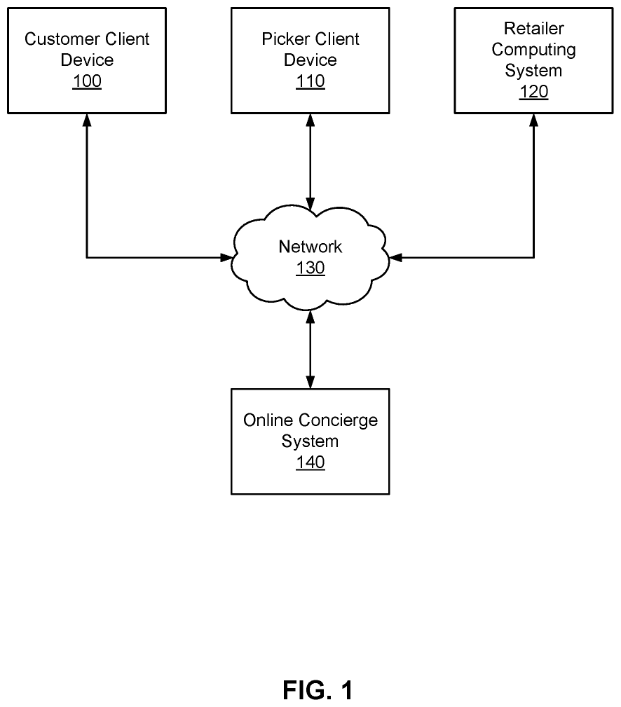

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention. Furthermore, in other embodiments, the online concierge system 140 may be replaced by an online system configured to retrieve content for display and to transmit the content to one or more customer client devices 100 or one or more picker client devices 110 for display.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or a desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the items should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer location. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

As the picker services orders, the picker client device 110 may communicate data to the online concierge system 140 in the form of data points. Each data point may include various types of data, such as information describing an action performed by the picker, a latitude, a longitude, an elevation, or a speed of the picker client device 110, a time at which the data point was received, information identifying an order being serviced by the picker, or any other suitable types of data. The picker client device 110 may include various sensors (e.g., an accelerometer, an altimeter, a gyroscope, a GPS sensor, a Bluetooth sensor, etc.) that are capable of detecting various signals (e.g., speed, elevation, orientation, location, Bluetooth connectivity, etc.) and may communicate a data point to the online concierge system 140 when a signal or a signal change is detected by a sensor included on the picker client device 110. Data points also may be communicated by the picker client device 110 to the online concierge system 140 at periodic intervals (e.g., every 15 seconds), when data is manually entered into the picker client device 110, when the picker client device 110 enters or exits a virtual boundary (e.g., a geofence), or upon any other suitable event, as further described below.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 may provide item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

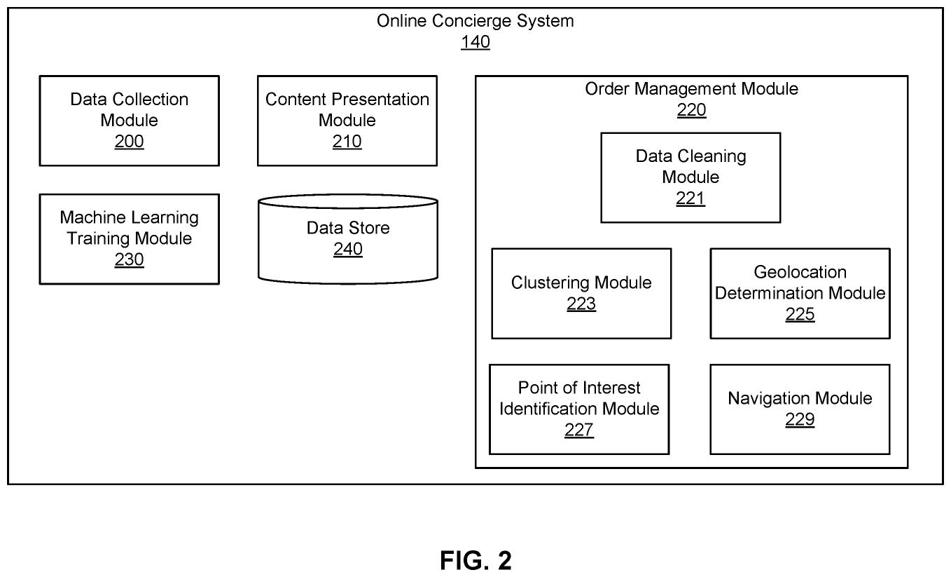

As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the items. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular retailer location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer who placed the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

The order management module 220 may determine a geolocation associated with an order and identify a navigation path for servicing the order. For example, the order management module 220 may determine a geolocation associated with a retailer location from which an order is to be picked up or a geolocation associated with a delivery location to which the order is to be delivered. In this example, if the retailer location or the delivery location is a unit (e.g., an apartment, suite, office, kiosk, store, etc.) within a building having multiple units (e.g., an apartment complex, an office building, a mall, etc.), the order management module 220 also may identify a navigation path for servicing the order. In the above example, the geolocation and navigation path are then sent to a picker client device 110 associated with a picker servicing the order. Continuing with this example, once the picker arrives at the retailer location or the delivery location (e.g., in a parking spot near the building), the navigation path may guide the picker from a location of the picker client device 110 to the unit (e.g., via a sequence of instructions, a map, etc.). Components of the order management module 220 involved in determining a geolocation associated with an order and identifying a navigation path for servicing the order include a data cleaning module 221, a clustering module 223, a geolocation determination module 225, a point of interest identification module 227, and a navigation module 229, which are further described below.

The order management module 220 receives data points from picker client devices 110. Data points may be received from a picker client device 110 at periodic intervals (e.g., every 15 seconds) or when a signal (e.g., speed, elevation, orientation, location, Bluetooth connectivity, etc.) or a change in signal is detected by a sensor (e.g., an accelerometer, an altimeter, a gyroscope, a GPS sensor, a Bluetooth sensor, etc.) included on the picker client device 110. Data points also may be received from a picker client device 110 when data is manually entered into the picker client device 110, when the picker client device 110 enters or exits a virtual boundary (e.g., a geofence), or upon any other suitable event. For example, a data point may be received from a picker client device 110 when data is manually entered into the picker client device 110 by a picker indicating that the picker has arrived at a retailer location or a delivery location, picked up an order from a retailer location, or delivered an order to a delivery location. As an additional example, a data point may be received from a picker client device 110 when the picker client device 110 loses connection (e.g., Bluetooth connectivity) with a vehicle or when the picker client device 110 enters or exits a geofence associated with a building in which a retailer location or a delivery location is located.

Each data point received from a picker client device 110 may include various types of data. Examples of such data include information describing an action performed by a picker associated with the picker client device 110, a latitude, a longitude, an elevation, or a speed of the picker client device 110, a time at which the data point was received, information identifying an order being serviced by the picker, or any other suitable types of data. For example, a data point may indicate whether a picker was picking up an order from a retailer location, delivering the order to a delivery location, or arriving at the retailer/delivery location. In this example, the data point also may include latitude and longitude coordinates of a picker client device 110 associated with the picker, an elevation and a speed of the picker client device 110, a timestamp indicating when the data point was received, and an order number for the order.

In some embodiments, the data cleaning module 221 may clean up data points received by the order management module 220 by eliminating noisy data. In some embodiments, the data cleaning module 221 may eliminate one or more data points that are unlikely to be valid based on a speed associated with each data point. For example, suppose that data points received by the order management module 220 indicate that pickers have picked up orders from one or more retailer locations, delivered orders to one or more delivery locations, or arrived at one or more retailer/delivery locations. In this example, data points associated with speeds that are less than five miles per hour are likely to be valid since they should have been received when pickers were parked, were walking to or from their car to delivery locations or retailer locations, etc., while data points associated with speeds that are five miles per hour or more are likely to be invalid because they were probably received while pickers were driving, biking, etc. Continuing with this example, the data cleaning module 221 may eliminate the data points associated with speeds of five miles per hour or more since the speeds indicate these data points were unlikely to have been received when the pickers actually arrived, picked up orders, or delivered orders.

In various embodiments, the data cleaning module 221 also may clean up data points received by the order management module 220 by applying an algorithm. In such embodiments, using the algorithm, the data cleaning module 221 may combine data points into sets and eliminate data points corresponding to outliers based on the sets of data points that are obtained. For example, beginning with sets of individual data points, the data cleaning module 221 may apply a Union-Find algorithm, such that the data cleaning module 221 may combine different sets of data points including a pair of data points if locations associated with the pair of data points are within a threshold distance of each other (e.g., a Haversine distance of 20 meters). In this example, the data cleaning module 221 may continue combining the resulting sets of data points until different sets of data points can no longer be combined or until a single set of data points is obtained. In the above example, the data cleaning module 221 may then eliminate any sets of data points that include fewer than a threshold number of data points (e.g., fewer than three data points).

The clustering module 223 executes a clustering process on one or more sets of data points received by the order management module 220. In various embodiments, the clustering module 223 executes the clustering process on a set of data points associated with arriving at one or more retailer locations or one or more delivery locations. For example, the clustering module 223 may execute the clustering process on a set of data points that includes a data point received from a picker client device 110 when a picker associated with the picker client device 110 parked their vehicle in a parking lot for a retailer location from which an order was to be picked up or in a parking spot for a delivery location to which the order was to be delivered. In some embodiments, the clustering module 223 also or alternatively executes the clustering process on an additional set of data points associated with picking up orders from one or more retailer locations or delivering orders to one or more delivery locations. In the above example, the clustering module 223 also or alternatively may execute the clustering process on a set of data points that includes a data point received from a picker client device 110 when a picker associated with the picker client device 110 collected one or more items included in an order to be delivered to a customer from a retailer location or when the picker handed the order to the customer at a delivery location.

To execute the clustering process, the clustering module 223 generates one or more clusters associated with a location from one or more sets of data points and identifies a cluster associated with the location based on one or more sets of data points included in each cluster. The cluster(s) may be generated using a clustering algorithm (e.g., k-means clustering), while the cluster associated with the location may be identified based on a number of data points included in each cluster. For example, the clustering module 223 may execute the clustering process on one or more sets of data points by generating, from the set(s) of data points, one or more clusters of data points associated with a location using a k-means clustering algorithm and identifying a cluster associated with the location that includes the greatest number of data points.

The geolocation determination module 225 determines a geolocation associated with a location (e.g., a retailer location or a delivery location). The geolocation determination module 225 may determine the geolocation associated with the location based on one or more sets of data points included in a cluster identified by the clustering module 223. For example, suppose that the clustering module 223 has executed the clustering process on one or more sets of data points associated with a delivery location, such that the clustering module 223 has identified a cluster associated with the delivery location (e.g., a cluster that includes the greatest number of data points). In this example, the geolocation determination module 225 may identify a latitude and a longitude associated with each data point included in the identified cluster and determine the geolocation associated with the delivery location based on a centroid for the identified cluster (i.e., based on an average latitude and an average longitude associated with the data points included in the identified cluster).

The point of interest identification module 227 may identify one or more points of interest associated with a location (e.g., a retailer location or a delivery location). Points of interest associated with a location may include one or more parking spots (e.g., a parking lot), an entrance, an exit, an elevator, a set of steps (e.g., a staircase, an escalator, etc.), a security desk, a congestion area, or any other suitable types of waypoints associated with a location. The point of interest identification module 227 may identify one or more points of interest associated with a location based on information included in data points received by the order management module 220 and one or more rules applied to the data points. For example, based on information identifying orders being serviced included in data points received by the order management module 220, the point of interest identification module 227 may identify a set of data points associated with servicing a set of orders, in which the set of orders were to be picked up from a retailer location within a mall. In this example, based on various rules applied to the set of data points, the point of interest identification module 227 may identify points of interest associated with the retailer location corresponding to a parking spot, an entrance/exit, and a set of steps. In some embodiments, a point of interest associated with a location identified by the point of interest identification module 227 may be verified (e.g., via manual feedback from a picker client device 110).

Various rules may be applied by the point of interest identification module 227 to data points received by the order management module 220 to identify points of interest. A rule may identify a point of interest corresponding to a parking spot when a set of data points indicates a picker client device 110 lost connection (e.g., Bluetooth connectivity) with a vehicle. In some embodiments, a rule may identify a point of interest corresponding to an entrance/exit of a building when a set of data points indicates a picker client device 110 entered/exited a geofence associated with the building. In such embodiments, the geofence associated with the building may be provided by a third-party system (e.g., a geofence API provider). In various embodiments, a rule may identify a point of interest corresponding to an elevator when a set of data points indicates a picker client device 110 changed elevation at a speed that is at least a threshold speed or when the picker client device 110 changed elevation while moving less than a threshold speed in a horizontal direction. A rule also may identify a point of interest corresponding to a set of steps (e.g., a staircase, an escalator, etc.) when a set of data points indicates a picker client device 110 changed elevation at a speed that is less than a threshold speed or changed elevation while moving at least a threshold speed in a horizontal direction. Yet another rule may identify a point of interest corresponding to a security desk when a set of data points indicates a picker client device 110 stopped moving within a building and subsequently moved to a delivery location. In some embodiments, a rule may identify a point of interest corresponding to a congestion area when a set of data points indicates a picker client device 110 was moving less than a threshold speed.

In some embodiments, the point of interest identification module 227 may associate a point of interest with a set of locations. In such embodiments, the point of interest identification module 227 may determine an association among the set of locations based on an address associated with each location. For example, the point of interest identification module 227 may determine that all apartments or offices with the same address but different apartment or suite numbers are associated with each other. The point of interest identification module 227 also may determine an association among a set of locations based on a geocoding method applied to an address associated with each location. For example, the point of interest identification module 227 may calculate the geohash of addresses for single-family homes that have the same street name and zip code using a geohash length of 7, which has a precision of less than 100 meters. In this example, all addresses with the same geohash may be associated with each other. As an additional example, the point of interest identification module 227 may calculate the geohash of addresses for townhomes or condos that have the same street name and zip code using a geohash length of 8, which has a precision of less than 20 meters. In this example, all addresses with the same geohash may be associated with each other. Once the point of interest identification module 227 has determined an association among a set of locations and has identified a point of interest associated with a location included among the set of locations, as described above, the point of interest identification module 227 may associate the point of interest with the set of locations. In the above examples, all addresses that are associated with each other may be associated with the same point(s) of interest.

The navigation module 229 identifies one or more pairs of data points associated with a location (e.g., a retailer location or a delivery location). Each pair of data points identified by the navigation module 229 is associated with an order and includes a first data point associated with arriving at a retailer location or a delivery location and a second data point associated with picking up the order from the retailer location or delivering the order to the delivery location. For example, suppose that a pair of data points identified by the navigation module 229 is associated with a retailer location and an order placed with the online concierge system 140. In this example, one data point may be associated with a picker arriving at the retailer location (e.g., parking at a parking lot for the retailer location) and the other data point may be associated with the picker picking up the order from the retailer location (e.g., collecting one or more items included in the order from the retailer location). Continuing with the above example, another pair of data points identified by the navigation module 229 associated with the retailer location may be associated with a different order placed with the online concierge system 140 and may include a data point associated with another picker arriving at the retailer location and another data point associated with this picker picking up this order from the retailer location.

In some embodiments, the navigation module 229 also may identify one or more points of interest included in a previous navigation path associated with a pair of data points identified by the navigation module 229. In such embodiments, the navigation module 229 may identify the point(s) of interest based on data included in the pair of data points that match data included in data points used by the point of interest identification module 227 to identify the point(s) of interest. For example, suppose that a pair of data points associated with a delivery location includes one data point associated with a picker arriving at the delivery location and another data point associated with the picker delivering a previous order to the delivery location. In this example, suppose also that various points of interest (e.g., an entrance/exit, a staircase, an elevator, a security desk, etc.) associated with the delivery location have been identified by the point of interest identification module 227 by applying one or more rules to data points associated with the delivery location. In this example, the navigation module 229 may identify one or more of the points of interest included in a previous navigation path associated with the pair of data points if data identifying the previous order being serviced included in the data points used by the point of interest identification module 227 to identify the point(s) of interest match data included in the pair of data points.

Once the navigation module 229 has identified one or more pairs of data points associated with a location (e.g., a retailer location or a delivery location), the navigation module 229 may determine a difference between a pair of times associated with each pair of data points. For example, based on a timestamp included in each data point, the navigation module 229 may determine a difference between a pair of times associated with each pair of data points. In this example, the difference may correspond to an amount of time (e.g., a number of seconds, minutes, hours, etc.) that elapsed between a time that a picker arrived at a retailer location or a delivery location and a time that the picker picked up an order from the retailer location or delivered the order to a delivery location, respectively.

The navigation module 229 identifies a navigation path including a sequence of points of interest for servicing an order. The navigation module 229 may do so based on one or more points of interest associated with a location associated with the order and a difference between a pair of times associated with each pair of data points associated with the location. In some embodiments, the navigation module 229 may include a point of interest in the navigation path if the point of interest is associated with a minimum difference between a pair of times associated with each pair of data points associated with the location. For example, suppose that a delivery location associated with an order is an apartment in an apartment building and that points of interest associated with the delivery location include three entrances to the building. In this example, suppose also that the navigation module 229 has determined a difference between each pair of times associated with each pair of data points associated with the delivery location and has identified one or more points of interest included in a previous navigation path associated with each pair of data points. In the above example, suppose also that the navigation module 229 has determined a difference of 15 minutes between seven pairs of times associated with a previous navigation path that included a first entrance, a difference of 11 minutes between 12 pairs of times associated with a previous navigation path that included a second entrance, and a difference of 20 minutes between 13 pairs of times associated with a previous navigation path that included a third entrance. Continuing with this example, the navigation module 229 may identify a navigation path including a sequence of points of interest for servicing the order that includes the second entrance. In various embodiments, the navigation module 229 may include a point of interest in a navigation path for servicing an order if the point of interest is associated with a minimum number of steps (e.g., flights of stairs) included in the navigation path. For example, the navigation module 229 may include a point of interest corresponding to an elevator in a navigation path for servicing an order to minimize the number of steps included in the navigation path.

The navigation module 229 also may identify a navigation path including a sequence of points of interest for servicing an order based on additional factors. In some embodiments, the navigation module 229 may identify the navigation path based on a set of attributes of the order that may affect whether one navigation path is more efficient than another navigation path. Attributes of the order may include a weight associated with the order, a number of items included in the order, a volume associated with the order, or any other suitable attributes of an order that may affect an efficiency of a navigation path for servicing the order. For example, if an order includes heavy or bulky items, the navigation module 229 may identify a navigation path including a sequence of points of interest for servicing the order that includes an elevator rather than a staircase. Alternatively, in the above example, if the order includes only a few light items and the delivery location is on the second floor of a building, the navigation module 229 may identify a navigation path including a sequence of points of interest for servicing the order that includes the staircase rather than the elevator.

In some embodiments, the navigation module 229 also may identify a navigation path including a sequence of points of interest for servicing an order based on a set of attributes of a picker servicing the order that may affect whether one navigation path is more efficient than another navigation path. Attributes of a picker may include a physical limitation associated with the picker, an age of the picker, a preference associated with the picker, or any other suitable attributes of a picker that may affect an efficiency of a navigation path for servicing the order. For example, if a picker servicing an order prefers not to climb stairs, the navigation module 229 may identify a navigation path including a sequence of points of interest for servicing the order that includes an elevator rather than a staircase. Alternatively, in the above example, if the picker has no preferences or physical limitations related to steps and the delivery location is on a second floor of a building, the navigation module 229 may identify a navigation path including a sequence of points of interest for servicing the order that includes a staircase rather than an elevator.

The order management module 220 may send a geolocation associated with a location (e.g., a retailer location or a delivery location) associated with an order to a picker client device 110 associated with a picker servicing the order. The order management module 220 may send the geolocation to the picker client device 110 in the form of coordinates (e.g., latitude and longitude coordinates), navigation instructions for navigating to the geolocation associated with the location, or via any other suitable form. In embodiments in which the geolocation is sent in the form of navigation instructions, the navigation instructions may include a sequence of instructions, a map, or various elements (e.g., text, images, sounds, etc.), and may be interactive. For example, the order management module 220 may send the geolocation in the form of turn-by-turn instructions and a map that are updated as the location of the picker client device 110 changes.

The order management module 220 also may send a navigation path including a sequence of points of interest for servicing an order to a picker client device 110 associated with a picker servicing the order. The order management module 220 may send the navigation path to the picker client device 110 in association with a geolocation associated with a location associated with the order (e.g., when the order is transmitted to the picker). Alternatively, the order management module 220 may send the navigation path to the picker client device 110 after the geolocation associated with the location is sent to the picker client device (e.g., once the picker client device 110 is within a threshold distance of the geolocation, when information indicating the picker has arrived at the location is received from the picker client device 110, etc.).

Similar to navigation instructions for navigating to a geolocation associated with a location, a navigation path may include a sequence of instructions, a map, or various elements (e.g., text, images, sounds, etc.), and may be interactive. For example, a navigation path may include a sequence of instructions, a map or elements (e.g., arrows, augmented reality elements) overlaid onto a map or an image of a location, verbal instructions, etc. In this example, the navigation path may include turn-by-turn instructions telling a picker where to park, which entrance of a building to use, which way to turn to arrive at a delivery location, a staircase, or an elevator, how far to travel down a hallway, how many flights of stairs or floors to travel, etc. Continuing with this example, the navigation path may be interactive (e.g., by updating as the picker client device 110 associated with the picker moves, by allowing the picker to zoom into a map, etc.). In embodiments in which a navigation path includes a map of a location, the map may include one or more points of interest associated with the location, allowing a picker to more easily navigate to the point(s) of interest (e.g., to meet a customer at the top of a staircase or to pick up or drop off an order at a security desk).

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, the hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data. In some embodiments, the data store 240 also stores data points received by the order management module 220 from picker client devices 110. Furthermore, in embodiments in which the data cleaning module 221 cleans up data points, the data cleaning module 221 may eliminate noisy data from the data store 240.

Determining a Geolocation and a Navigation Path Associated with an Order Placed with an Online Concierge System

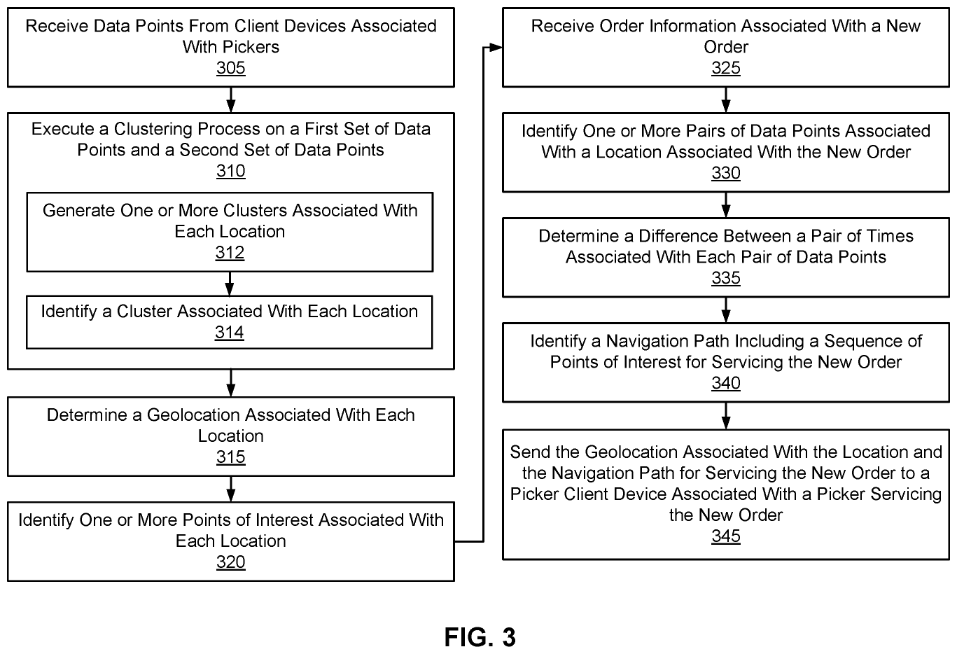

FIG. 3 is a flowchart of a method for determining a geolocation and a navigation path associated with an order placed with an online concierge system 140, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140) in various embodiments, while in other embodiments, the steps of the method are performed by any online system capable of retrieving items. Additionally, each of these steps may be performed automatically by the online concierge system without human intervention.

The online concierge system 140 receives (step 305, e.g., via the order management module 220) data points from picker client devices 110 associated with pickers associated with the online concierge system 140. Data points may be received 305 from a picker client device 110 at periodic intervals (e.g., every 15 seconds) or when a signal (e.g., speed, elevation, orientation, location, Bluetooth connectivity, etc.) or a change in signal is detected by a sensor (e.g., an accelerometer, an altimeter, a gyroscope, a GPS sensor, a Bluetooth sensor, etc.) included on the picker client device 110. Data points also may be received 305 from a picker client device 110 when data is manually entered into the picker client device 110, when the picker client device 110 enters or exits a virtual boundary (e.g., a geofence), or upon any other suitable event. For example, a data point may be received 305 from a picker client device 110 when data is manually entered into the picker client device 110 by a picker indicating that the picker has arrived at a retailer location or a delivery location, picked up an order from a retailer location, or delivered an order to a delivery location. As an additional example, a data point may be received 305 from a picker client device 110 when the picker client device 110 loses connection (e.g., Bluetooth connectivity) with a vehicle or when the picker client device 110 enters or exits a geofence associated with a building in which a retailer location or a delivery location is located.

Each data point received 305 from a picker client device 110 may include various types of data. Examples of such data include information describing an action performed by a picker associated with the picker client device 110, a latitude, a longitude, an elevation, or a speed of the picker client device 110, a time at which the data point was received 305, information identifying an order being serviced by the picker, or any other suitable types of data. For example, a data point may indicate whether a picker was picking up an order from a retailer location, delivering the order to a delivery location, or arriving at the retailer/delivery location. In this example, the data point also may include latitude and longitude coordinates of a picker client device 110 associated with the picker, an elevation and a speed of the picker client device 110, a timestamp indicating when the data point was received 305, and an order number for the order.

In some embodiments, the online concierge system 140 may clean up data points received 305 by the online concierge system 140 by eliminating noisy data (e.g., using the data cleaning module 221). In some embodiments, the online concierge system 140 may eliminate one or more data points that are unlikely to be valid based on a speed associated with each data point. For example, suppose that data points received 305 by the online concierge system 140 indicate that pickers have picked up orders from one or more retailer locations, delivered orders to one or more delivery locations, or arrived at one or more retailer/delivery locations. In this example, data points associated with speeds that are less than five miles per hour are likely to be valid since they should have been received 305 when pickers were parked, were walking to or from their car to delivery locations or retailer locations, etc., while data points associated with speeds that are five miles per hour or more are likely to be invalid because they were probably received 305 while pickers were driving, biking, etc. Continuing with this example, the online concierge system 140 may eliminate the data points associated with speeds of five miles per hour or more since the speeds indicate these data points were unlikely to have been received 305 when the pickers actually arrived, picked up orders, or delivered orders.

In various embodiments, the online concierge system 140 also may clean up data points received 305 by the online concierge system 140 by applying an algorithm (e.g., using the data cleaning module 221). In such embodiments, using the algorithm, the online concierge system 140 may combine data points into sets and eliminate data points corresponding to outliers based on the sets of data points that are obtained. For example, beginning with sets of individual data points, the online concierge system 140 may apply a Union-Find algorithm, such that the online concierge system 140 may combine different sets of data points including a pair of data points if locations associated with the pair of data points are within a threshold distance of each other (e.g., a Haversine distance of 20 meters). In this example, the online concierge system 140 may continue combining the resulting sets of data points until different sets of data points can no longer be combined or until a single set of data points is obtained. In the above example, the online concierge system 140 may then eliminate any sets of data points that include fewer than a threshold number of data points (e.g., fewer than three data points).

The online concierge system 140 then executes 310 (e.g., using the clustering module 223) a clustering process on one or more sets of data points included among the data points received 305 by the online concierge system 140. In various embodiments, the online concierge system 140 executes 310 the clustering process on a first set of data points associated with arriving at one or more locations included among a plurality of locations (e.g., retailer locations or delivery locations). For example, the online concierge system 140 may execute 310 the clustering process on the first set of data points that includes a data point received 305 from a picker client device 110 when a picker associated with the picker client device 110 parked their vehicle in a parking lot for a retailer location from which an order was to be picked up or in a parking spot for a delivery location to which the order was to be delivered. In some embodiments, the online concierge system 140 also or alternatively executes 310 the clustering process on a second set of data points associated with picking up orders from one or more retailer locations included among the plurality of locations or delivering orders to one or more delivery locations included among the plurality of locations. In the above example, the online concierge system 140 also or alternatively may execute 310 the clustering process on the second set of data points that includes a data point received 305 from a picker client device 110 when a picker associated with the picker client device 110 collected one or more items included in an order to be delivered to a customer from a retailer location or when the picker handed the order to the customer at a delivery location.

To execute 310 the clustering process, the online concierge system 140 generates 312 (e.g., using the clustering module 223), from the first and/or second set of data points, one or more clusters associated with each location included among the plurality of locations and identifies 314 (e.g., using the clustering module 223) a cluster associated with each location based on the first and/or second set of data points included in each cluster. The cluster(s) may be generated 312 using a clustering algorithm (e.g., k-means clustering), while the cluster associated with each location may be identified 314 based on a number of data points included in each cluster. For example, the online concierge system 140 may execute 310 the clustering process on the first and/or second set of data points by generating 312, from the first and/or second set of data points, one or more clusters of data points associated with each location using a k-means clustering algorithm and identifying 314 a cluster associated with each location that includes the greatest number of data points.

The online concierge system 140 then determines 315 (e.g., using the geolocation determination module 225) a geolocation associated with each location included among the plurality of locations. The online concierge system 140 may determine 315 the geolocation associated with each location based on the first and/or second set of data points included in the cluster identified 314 by the online concierge system 140. For example, suppose that the online concierge system 140 has executed 310 the clustering process on the first and/or second set of data points associated with a delivery location, such that the online concierge system 140 has identified 314 a cluster associated with the delivery location (e.g., a cluster that includes the greatest number of data points). In this example, the online concierge system 140 may identify a latitude and a longitude associated with each data point included in the identified cluster and determine 315 the geolocation associated with the delivery location based on a centroid for the identified cluster (i.e., based on an average latitude and an average longitude associated with the data points included in the identified cluster).

The online concierge system 140 may identify 320 (e.g., using the point of interest identification module 227) one or more points of interest associated with each location included among the plurality of locations. Points of interest associated with a location may include one or more parking spots (e.g., a parking lot), an entrance, an exit, an elevator, a set of steps (e.g., a staircase, an escalator, etc.), a security desk, a congestion area, or any other suitable types of waypoints associated with a location. The online concierge system 140 may identify 320 one or more points of interest associated with each location based on information included in data points received 305 by the online concierge system 140 and one or more rules applied to the data points. For example, based on information identifying orders being serviced included in data points received 305 by the online concierge system 140, the online concierge system 140 may identify a set of data points associated with servicing a set of orders, in which the set of orders were to be picked up from a retailer location within a mall. In this example, based on various rules applied to the set of data points, the online concierge system 140 may identify (step 320) points of interest associated with the retailer location corresponding to a parking spot, an entrance/exit, and a set of steps. In some embodiments, a point of interest associated with a location identified 320 by the online concierge system 140 may be verified (e.g., via manual feedback from a picker client device 110).

Various rules may be applied by the online concierge system 140 to the data points received 305 by the online concierge system 140 to identify (step 320) points of interest. A rule may identify 320 a point of interest corresponding to a parking spot when a set of data points indicates a picker client device 110 lost connection (e.g., Bluetooth connectivity) with a vehicle. In some embodiments, a rule may identify 320 a point of interest corresponding to an entrance/exit of a building when a set of data points indicates a picker client device 110 entered/exited a geofence associated with the building. In such embodiments, the geofence associated with the building may be provided by a third-party system (e.g., a geofence API provider). In various embodiments, a rule may identify 320 a point of interest corresponding to an elevator when a set of data points indicates a picker client device 110 changed elevation at a speed that is at least a threshold speed or when the picker client device 110 changed elevation while moving less than a threshold speed in a horizontal direction. A rule also may identify 320 a point of interest corresponding to a set of steps (e.g., a staircase, an escalator, etc.) when a set of data points indicates a picker client device 110 changed elevation at a speed that is less than a threshold speed or changed elevation while moving at least a threshold speed in a horizontal direction. Yet another rule may identify 320 a point of interest corresponding to a security desk when a set of data points indicates a picker client device 110 stopped moving within a building and subsequently moved to a delivery location. In some embodiments, a rule may identify 320 a point of interest corresponding to a congestion area when a set of data points indicates a picker client device 110 was moving less than a threshold speed.

In some embodiments, the online concierge system 140 may associate (e.g., using the point of interest identification module 227) a point of interest with a set of locations. In such embodiments, the online concierge system 140 may determine (e.g., using the point of interest identification module 227) an association among the set of locations based on an address associated with each location. For example, the online concierge system 140 may determine that all apartments or offices with the same address but different apartment or suite numbers are associated with each other. The online concierge system 140 also may determine an association among a set of locations based on a geocoding method applied to an address associated with each location. For example, the online concierge system 140 may calculate the geohash of addresses for single-family homes that have the same street name and zip code using a geohash length of 7, which has a precision of less than 100 meters. In this example, all addresses with the same geohash may be associated with each other. As an additional example, the online concierge system 140 may calculate the geohash of addresses for townhomes or condos that have the same street name and zip code using a geohash length of 8, which has a precision of less than 20 meters. In this example, all addresses with the same geohash may be associated with each other. Once the online concierge system 140 has determined an association among a set of locations and has identified 320 a point of interest associated with a location included among the set of locations, as described above, the online concierge system 140 may associate the point of interest with the set of locations. In the above examples, all addresses that are associated with each other may be associated with the same point(s) of interest.

The online concierge system 140 then receives 325 (e.g., via the order management module 220) order information describing a new order placed with the online concierge system 140. The order information describes a location (e.g., a retailer location or a delivery location) associated with the new order. For example, the online concierge system 140 receives 325 the order information associated with the new order from a customer client device 100 associated with a customer who placed the new order. In this example, the order information may include a retailer location from which the new order is to be picked up, a delivery location to which the new order is to be delivered, and a delivery time associated with the new order. In this example, the order information also may include various attributes of the new order, such as a weight associated with the new order, a number of items included in the new order, a volume associated with the new order, instructions that specify how the items should be collected or delivered, or any other suitable attributes.

From the data points received 305 by the online concierge system 140, the online concierge system 140 identifies 330 (e.g., using the navigation module 229), one or more pairs of data points associated with the location associated with the new order. Each pair of data points identified 330 by the online concierge system 140 is associated with an order and includes a first data point from the first set of data points and a second data point from the second set of data points. For example, suppose that a pair of data points identified 330 by the online concierge system 140 is associated with the location associated with the new order as well as a previous order placed with the online concierge system 140. In this example, one data point may be associated with a picker arriving at the location (e.g., parking at a parking lot for the location) and the other data point may be associated with the picker picking up the previous order from the location (e.g., collecting one or more items included in the previous order from the location). Continuing with the above example, another pair of data points identified 330 by the online concierge system 140 associated with the location associated with the new order also may be associated with another previous order placed with the online concierge system 140 and may include a data point associated with another picker arriving at the location and another data point associated with this picker picking up this previous order from the location.

In some embodiments, the online concierge system 140 also may identify (e.g., using the navigation module 229) one or more points of interest included in a previous navigation path associated with a pair of data points identified 330 by the online concierge system 140. In such embodiments, the online concierge system 140 may identify the point(s) of interest based on data included in the pair of data points that match data included in data points used by the online concierge system 140 to identify 320 the point(s) of interest. For example, suppose that a pair of data points associated with the location associated with the new order includes one data point associated with a picker arriving at the location and another data point associated with the picker delivering a previous order to the location. In this example, suppose also that various points of interest (e.g., an entrance/exit, a staircase, an elevator, a security desk, etc.) associated with the location have been identified 320 by the online concierge system 140 by applying one or more rules to data points associated with the location. In this example, the online concierge system 140 may identify one or more of the points of interest included in a previous navigation path associated with the pair of data points if data identifying the previous order being serviced included in the data points used by the online concierge system 140 to identify 320 the point(s) of interest match data included in the pair of data points.

Once the online concierge system 140 has identified 330 one or more pairs of data points associated with the location associated with the new order, the online concierge system 140 may determine 335 (e.g., using the navigation module 229) a difference between a pair of times associated with each pair of data points. For example, based on a timestamp included in each data point, the online concierge system 140 may determine 335 a difference between a pair of times associated with each pair of data points. In this example, the difference may correspond to an amount of time (e.g., a number of seconds, minutes, hours, etc.) that elapsed between a time that a picker arrived at the location associated with the new order and a time that the picker picked up an order from the location or delivered the order to the location.

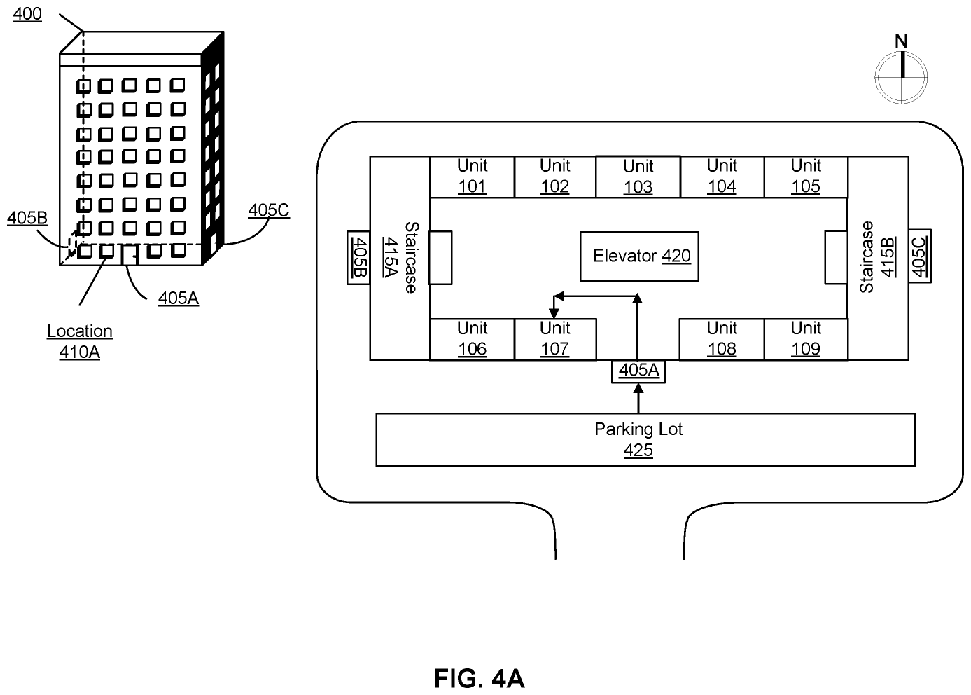

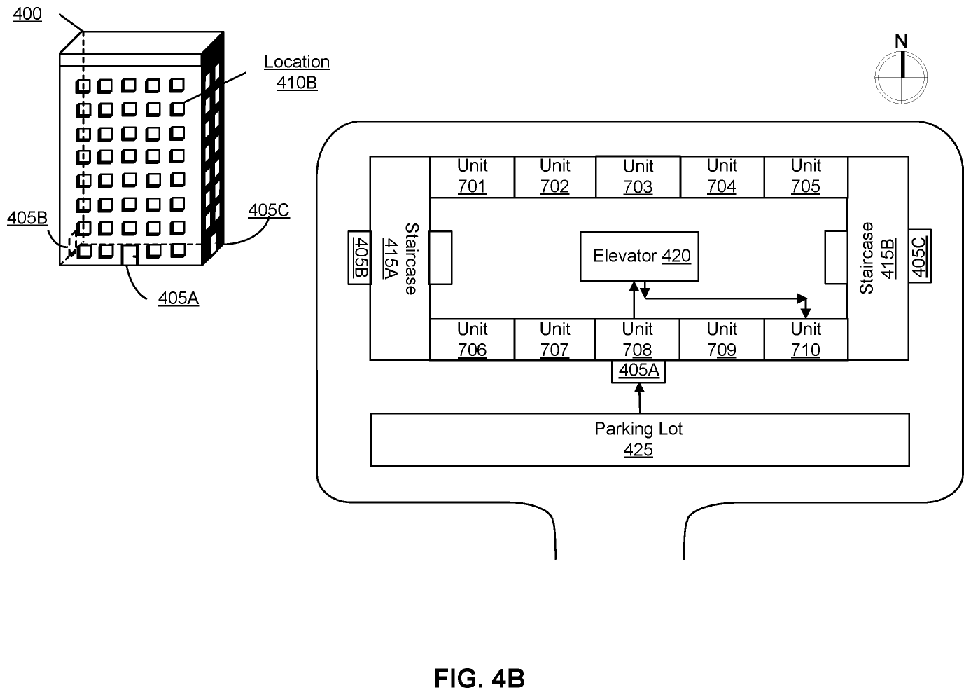

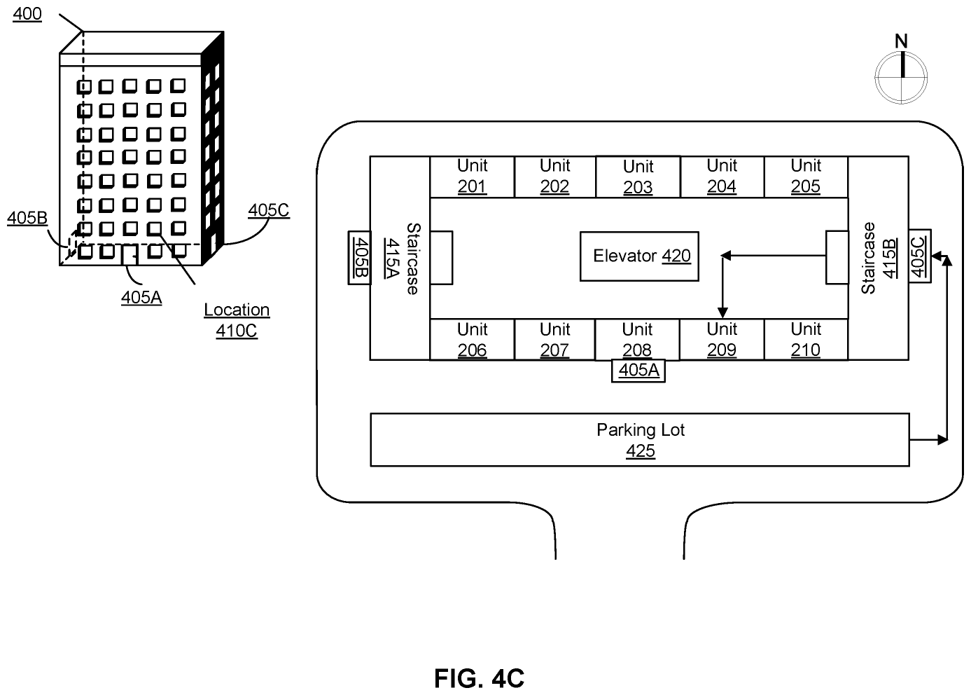

The online concierge system 140 then identifies 340 (e.g., using the navigation module 229) a navigation path including a sequence of points of interest for servicing the new order. The online concierge system 140 may do so based on one or more points of interest associated with the location associated with the new order and the difference between the pair of times associated with each pair of data points associated with the location. In some embodiments, the online concierge system 140 may include a point of interest in the navigation path if the point of interest is associated with a minimum difference between the pair of times associated with each pair of data points associated with the location. For example, as shown in FIG. 4A, which illustrates an example of a navigation path for servicing an order, in accordance with one or more embodiments, suppose that the location 410A associated with the new order is a unit (unit 107) on the first floor of a building 400 and that points of interest associated with the unit include three entrances 405A-C to the building 400. In this example, suppose also that the online concierge system 140 has determined 335 a difference between each pair of times associated with each pair of data points associated with the location 410A and has identified one or more points of interest included in a previous navigation path associated with each pair of data points. In the above example, suppose also that the online concierge system 140 has determined 335 a difference of 8 minutes between seven pairs of times associated with a previous navigation path that included a first entrance 405A, a difference of 10 minutes between 12 pairs of times associated with a previous navigation path that included a second entrance 405B, and a difference of 12 minutes between 13 pairs of times associated with a previous navigation path that included a third entrance 405C. Continuing with this example, the online concierge system 140 may identify 340 the navigation path for servicing the new order that includes the first entrance 405A.

In various embodiments, the online concierge system 140 may include a point of interest in the navigation path for servicing the new order if the point of interest is associated with a minimum number of steps (e.g., flights of stairs) included in the navigation path. For example, as shown in FIG. 4B, which illustrates an additional example of a navigation path for servicing an order, in accordance with one or more embodiments, suppose that the location 410B associated with the new order is a unit (unit 710) on the seventh floor of the building 400 described in the example above. In this example, the online concierge system 140 may include a point of interest corresponding to an elevator 420 in the navigation path rather than a staircase 415 to minimize the number of steps included in the navigation path.

The online concierge system 140 also may identify 340 the navigation path for servicing the new order based on additional factors. In some embodiments, the online concierge system 140 may identify 340 the navigation path for servicing the new order based on a set of attributes of the new order that may affect whether one navigation path is more efficient than another navigation path. Attributes of the new order may include a weight associated with the new order, a number of items included in the new order, a volume associated with the new order, or any other suitable attributes of the new order that may affect an efficiency of a navigation path for servicing the new order. For example, if the new order includes heavy or bulky items, the online concierge system 140 may identify 340 the navigation path for servicing the new order that includes an elevator 420 rather than a staircase 415. Alternatively, as shown in FIG. 4C, which illustrates an additional example of a navigation path for servicing an order, in accordance with one or more embodiments, suppose that the location 410C associated with the new order is a unit (unit 209) on the second floor of the building 400 described in the examples above and the new order includes only a few light items. In this example, the online concierge system 140 may include a point of interest corresponding to a staircase 415B in the navigation path rather than the elevator 420.

In various embodiments, the online concierge system 140 also may identify 340 the navigation path for servicing the new order based on a set of attributes of a picker servicing the new order that may affect whether one navigation path is more efficient than another navigation path. Attributes of the picker may include a physical limitation associated with the picker, an age of the picker, a preference associated with the picker, or any other suitable attributes of the picker that may affect an efficiency of the navigation path for servicing the new order. For example, if the picker servicing the new order prefers not to climb stairs, the navigation path for servicing the new order identified 340 by the online concierge system 140 may include an elevator 420 rather than a staircase 415. Alternatively, in the above example, if the picker has no preferences or physical limitations related to steps, and the location 410 associated with the new order is on a second floor of a building 400, the navigation path identified 340 by the online concierge system 140 may include a staircase 415 rather than an elevator 420.

Referring back to FIG. 3, the online concierge system 140 may then send 345 (e.g., using the order management module 220) the geolocation associated with the location 410 associated with the new order to a picker client device 110 associated with the picker servicing the new order. The online concierge system 140 may send 345 the geolocation to the picker client device 110 in the form of coordinates (e.g., latitude and longitude coordinates), navigation instructions for navigating to the geolocation associated with the location 410, or via any other suitable form. In embodiments in which the geolocation is sent 345 in the form of navigation instructions, the navigation instructions may include a sequence of instructions, a map, or various elements (e.g., text, images, sounds, etc.), and may be interactive. For example, the online concierge system 140 may send 345 the geolocation in the form of turn-by-turn instructions and a map that are updated as the location of the picker client device 110 changes.

The online concierge system 140 also may send 345 (e.g., using the order management module 220) the navigation path including the sequence of points of interest for servicing the new order to the picker client device 110 associated with the picker servicing the new order. The online concierge system 140 may send 345 the navigation path to the picker client device 110 in association with the geolocation associated with the location 410 associated with the new order (e.g., when the new order is transmitted to the picker). Alternatively, the online concierge system 140 may send 345 the navigation path to the picker client device 110 after the geolocation is sent 345 to the picker client device 110 (e.g., once the picker client device 110 is within a threshold distance of the geolocation, when information indicating the picker has arrived at the location 410 is received from the picker client device 110, etc.).

Similar to navigation instructions for navigating to the geolocation, the navigation path may include a sequence of instructions, a map, or various elements (e.g., text, images, sounds, etc.), and may be interactive. In the example shown in FIG. 4A, the navigation path may include arrows overlaid onto the floorplan of the building 400 as well as turn-by-turn instructions telling the picker to park in the middle of the parking lot 425, enter the building 400 from the first entrance 405A, turn left at the elevator 420, and turn left again to arrive at the location 410A, which will be on the left. In the example shown in FIG. 4B, the navigation path may include arrows overlaid onto the floorplan of the building 400 as well as turn-by-turn instructions telling the picker to park in the middle of the parking lot 425, enter the building 400 from the first entrance 405A, travel to the seventh floor using the elevator 420, turn left, and travel a certain distance before arriving at the location 410B, which will be on the right. In the example shown in FIG. 4C, the navigation path may include turn-by-turn instructions telling the picker to park on the eastern side of the parking lot 425, enter the building 400 from the third entrance 405C, travel to the second floor using a staircase 415B, and arrive at the location 410C, which will be on the left. In the above examples, the navigation path may be interactive (e.g., by updating as the picker client device 110 associated with the picker moves, by allowing the picker to zoom into a map, etc.). For example, if the picker is unable to park on the eastern side of the parking lot 425 as shown in FIG. 4C, the navigation path may be updated to include turn-by-turn instructions telling the picker to enter the building 400 from a different entrance 405A-B that is closer to where the picker parked within the parking lot 425. In embodiments in which the navigation path includes a map of the location 410, the map may include one or more points of interest associated with the location 410, allowing the picker to more easily navigate to the point(s) of interest (e.g., to meet a customer at the top of a staircase or to pick up or drop off the new order at a security desk).

### Additional Considerations

The foregoing description of the embodiments has been presented for the purpose of illustration; a person of ordinary skill in the art would recognize that many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising, at a computer system comprising a processor and a computer-readable medium:
receiving, from a plurality of picker client devices associated with a plurality of pickers associated with an online concierge system, a plurality of data points comprising a first set of data points and a second set of data points, wherein the first set of data points is associated with arriving at one or more locations of a plurality of locations and the second set of data points is associated with picking up orders from one or more locations of the plurality of locations and delivering orders to one or more locations of the plurality of locations;
executing a clustering process on one or more of the first set of data points and the second set of data points, the clustering process comprising:
generating, from the one or more of the first set of data points and the second set of data points, one or more clusters associated with each location of the plurality of locations, and
identifying a cluster associated with each location of the plurality of locations based at least in part on the one or more of the first set of data points and the second set of data points included in each cluster of the one or more clusters;
determining a geolocation associated with each location of the plurality of locations based at least in part on the one or more of the first set of data points and the second set of data points included in the identified cluster;
identifying one or more points of interest associated with each location of the plurality of locations based at least in part on one or more rules applied to the plurality of data points;
receiving order information associated with a new order placed with the online concierge system, the order information describing a location associated with the new order;
identifying, from the plurality of data points, one or more pairs of data points associated with the location, wherein each pair of data points is associated with an order and includes a first data point from the first set of data points and a second data point from the second set of data points;
determining a difference between a pair of times associated with each pair of data points;
identifying a navigation path comprising a sequence of points of interest for servicing the new order based at least in part on the one or more points of interest associated with the location and the difference between the pair of times associated with each pair of data points; and
sending, to a picker client device associated with a picker servicing the new order, the geolocation associated with the location and the navigation path for servicing the new order.

2. The method of claim 1, wherein each data point of the plurality of data points comprises one or more selected from the group consisting of: information describing an action performed by a picker, a longitude, a latitude, an elevation, a speed, a time, and information identifying an order being serviced.

3. The method of claim 1, wherein the plurality of data points are received from the plurality of picker client devices based on one or more selected from the group consisting of: a periodic interval, a signal detected by a sensor of a picker client device, and a manual entry of data into a picker client device.

4. The method of claim 1, wherein the one or more points of interest associated with each location of the plurality of locations comprise one or more selected from the group consisting of: a parking spot, an entrance, an exit, an elevator, a staircase, a security desk, and a congestion area.

5. The method of claim 1, wherein identifying the navigation path comprising the sequence of points of interest for servicing the new order comprises:
inserting a point of interest in the navigation path if the point of interest is associated with a minimum of one or more of: the difference between the pair of times associated with each pair of data points and a number of steps included in the navigation path.

6. The method of claim 1, wherein the one or more rules applied to the plurality of data points are selected from the group consisting of: identifying a point of interest corresponding to a parking spot when a picker client device loses connection with a vehicle, identifying a point of interest corresponding to an entrance of a building when a picker client device enters a geofence associated with the building, identifying a point of interest corresponding to an exit of the building when a picker client device exits the geofence associated with the building, identifying a point of interest corresponding to an elevator when a picker client device changes elevation at a speed that is at least a threshold speed, identifying a point of interest corresponding to a staircase when a picker client device changes elevation at a speed that is less than a threshold speed, identifying a point of interest corresponding to a security desk when a picker client device stops moving within a building and subsequently moves to a delivery location, and identifying a point of interest corresponding to a congestion area when a picker client device moves less than a threshold speed.

7. The method of claim 1, further comprising:
determining an association among a set of locations based at least in part on an address associated with each location of the set of locations;
identifying a point of interest associated with a location included among the set of locations; and
associating the point of interest with each location of the set of locations.

8. The method of claim 1, wherein determining the geolocation associated with each location of the plurality of locations comprises:
identifying a latitude and a longitude associated with each data point of the one or more of the first set of data points and the second set of data points included in the identified cluster; and
determining the geolocation associated with each location of the plurality of locations based at least in part on an average latitude and an average longitude associated with the one or more of the first set of data points and the second set of data points included in the identified cluster.

9. The method of claim 1, wherein identifying the navigation path comprising the sequence of points of interest for servicing the new order is further based at least in part on a set of attributes associated with one or more of the new order and the picker servicing the new order, wherein the set of attributes comprises one or more selected from the group consisting of: a weight associated with the new order, a number of items included in the new order, a volume associated with the new order, a physical limitation associated with the picker, an age of the picker, and a preference associated with the picker.

10. The method of claim 1, further comprising:
eliminating one or more data points from the plurality of data points, wherein each data point of the one or more data points is associated with a speed that is at least a threshold speed; and
eliminating one or more additional data points from the plurality of data points based at least in part on a Union-Find algorithm and a Haversine distance between a pair of data points.

11. A computer program product comprising a non-transitory computer readable storage medium having instructions encoded thereon that, when executed by a processor, cause the processor to:
receive, from a plurality of picker client devices associated with a plurality of pickers associated with an online concierge system, a plurality of data points comprising a first set of data points and a second set of data points, wherein the first set of data points is associated with arriving at one or more locations of a plurality of locations and the second set of data points is associated with picking up orders from one or more locations of the plurality of locations and delivering orders to one or more locations of the plurality of locations;
execute a clustering process on one or more of the first set of data points and the second set of data points, the clustering process comprising:
generate, from the one or more of the first set of data points and the second set of data points, one or more clusters associated with each location of the plurality of locations, and
identify a cluster associated with each location of the plurality of locations based at least in part on the one or more of the first set of data points and the second set of data points included in each cluster of the one or more clusters;
determine a geolocation associated with each location of the plurality of locations based at least in part on the one or more of the first set of data points and the second set of data points included in the identified cluster;
identify one or more points of interest associated with each location of the plurality of locations based at least in part on one or more rules applied to the plurality of data points;
receive order information associated with a new order placed with the online concierge system, the order information describing a location associated with the new order;
identify, from the plurality of data points, one or more pairs of data points associated with the location, wherein each pair of data points is associated with an order and includes a first data point from the first set of data points and a second data point from the second set of data points;
determine a difference between a pair of times associated with each pair of data points;
identify a navigation path comprising a sequence of points of interest for servicing the new order based at least in part on the one or more points of interest associated with the location and the difference between the pair of times associated with each pair of data points; and
send, to a picker client device associated with a picker servicing the new order, the geolocation associated with the location and the navigation path for servicing the new order.

12. The computer program product of claim 11, wherein each data point of the plurality of data points comprises one or more selected from the group consisting of: information describing an action performed by a picker, a longitude, a latitude, an elevation, a speed, a time, and information identifying an order being serviced.

13. The computer program product of claim 11, wherein the plurality of data points are received from the plurality of picker client devices based on one or more selected from the group consisting of: a periodic interval, a signal detected by a sensor of a picker client device, and a manual entry of data into a picker client device.

14. The computer program product of claim 11, wherein the one or more points of interest associated with each location of the plurality of locations comprise one or more selected from the group consisting of: a parking spot, an entrance, an exit, an elevator, a staircase, a security desk, and a congestion area.

15. The computer program product of claim 11, wherein identify the navigation path comprising the sequence of points of interest for servicing the new order comprises:
insert a point of interest in the navigation path if the point of interest is associated with a minimum of one or more of: the difference between the pair of times associated with each pair of data points and a number of steps included in the navigation path.

16. The computer program product of claim 11, wherein the one or more rules applied to the plurality of data points are selected from the group consisting of: identifying a point of interest corresponding to a parking spot when a picker client device loses connection with a vehicle, identifying a point of interest corresponding to an entrance of a building when a picker client device enters a geofence associated with the building, identifying a point of interest corresponding to an exit of the building when a picker client device exits the geofence associated with the building, identifying a point of interest corresponding to an elevator when a picker client device changes elevation at a speed that is at least a threshold speed, identifying a point of interest corresponding to a staircase when a picker client device changes elevation at a speed that is less than a threshold speed, identifying a point of interest corresponding to a security desk when a picker client device stops moving within a building and subsequently moves to a delivery location, and identifying a point of interest corresponding to a congestion area when a picker client device moves less than a threshold speed.

17. The computer program product of claim 11, wherein the computer-readable storage medium further has instructions encoded thereon that, when executed by the processor, cause the processor to:
determine an association among a set of locations based at least in part on an address associated with each location of the set of locations;
identify a point of interest associated with a location included among the set of locations; and
associate the point of interest with each location of the set of locations.

18. The computer program product of claim 11, wherein determine the geolocation associated with each location of the plurality of locations comprises:
identify a latitude and a longitude associated with each data point of the one or more of the first set of data points and the second set of data points included in the identified cluster; and
determine the geolocation associated with each location of the plurality of locations based at least in part on an average latitude and an average longitude associated with the one or more of the first set of data points and the second set of data points included in the identified cluster.

19. The computer program product of claim 11, wherein identify the navigation path comprising the sequence of points of interest for servicing the new order is further based at least in part on a set of attributes associated with one or more of the new order and the picker servicing the new order, wherein the set of attributes comprises one or more selected from the group consisting of: a weight associated with the new order, a number of items included in the new order, a volume associated with the new order, a physical limitation associated with the picker, an age of the picker, and a preference associated with the picker.

20. A computer system comprising:
a processor; and
a non-transitory computer readable storage medium storing instructions that, when executed by the processor, cause the computer system to perform actions comprising:
receiving, from a plurality of picker client devices associated with a plurality of pickers associated with an online concierge system, a plurality of data points comprising a first set of data points and a second set of data points, wherein the first set of data points is associated with arriving at one or more locations of a plurality of locations and the second set of data points is associated with picking up orders from one or more locations of the plurality of locations and delivering orders to one or more locations of the plurality of locations;
executing a clustering process on one or more of the first set of data points and the second set of data points, the clustering process comprising:
generating, from the one or more of the first set of data points and the second set of data points, one or more clusters associated with each location of the plurality of locations, and
identifying a cluster associated with each location of the plurality of locations based at least in part on the one or more of the first set of data points and the second set of data points included in each cluster of the one or more clusters;
determining a geolocation associated with each location of the plurality of locations based at least in part on the one or more of the first set of data points and the second set of data points included in the identified cluster;
identifying one or more points of interest associated with each location of the plurality of locations based at least in part on one or more rules applied to the plurality of data points;
receiving order information associated with a new order placed with the online concierge system, the order information describing a location associated with the new order;
identifying, from the plurality of data points, one or more pairs of data points associated with the location, wherein each pair of data points is associated with an order and includes a first data point from the first set of data points and a second data point from the second set of data points;
determining a difference between a pair of times associated with each pair of data points;
identifying a navigation path comprising a sequence of points of interest for servicing the new order based at least in part on the one or more points of interest associated with the location and the difference between the pair of times associated with each pair of data points; and
sending, to a picker client device associated with a picker servicing the new order, the geolocation associated with the location and the navigation path for servicing the new order.
